(19) United States
(12) Patent Application Publication
(10) Pub. No.: US 2017/0120879 A1
(43) Pub. Date: May 4, 2017

(54) VEHICLE OUTRIGGER AND LANDING GEAR APPARATUS

(71) Applicant: J3I PTE. LTD., Singapore (SG)

(72) Inventor: Adrian Teck Hin Koh, Singapore (SG)

(21) Appl. No.: 15/041,608

(22) Filed: Feb. 11, 2016

(30) Foreign Application Priority Data
Nov. 4, 2015 (SG) 10201509084W

(51) Int. Cl. B60S 9/12

(52) U.S. Cl. CPC B60S 9/12

(57) ABSTRACT

To decrease the off-load turn-around time of HGVs, the invention involves inter alia a system including a vehicle outrigger and landing gear apparatus (VOLGA) adapted to support a load the apparatus including a goods supportable frame mountable to and detachable from a HGV; a plurality of pneumatically moveable outrigger arms fitted to the frame each moveable between a stowed and a deployed position; a landing gear including a ground contactable leg operatively connected to each outrigger arm and pneumatically moveable between a stowed and a deployed position to support the frame above the ground in the deployed position; and a plurality of locking pins each moveable between a locked and an unlocked position so as to lock each of the arms and legs in their stowed or deployed position; and a HGV including means to connect the vehicle's pneumatic system to the pneumatically operable arms and legs of the VOLGA.

### RELATED APPLICATIONS

This application claims priority to Singapore Patent Application No. 10201509084W, filed Nov. 4, 2015, incorporated by reference herein.

### FIELD OF THE INVENTION

The present invention relates to vehicle outrigger and landing gear apparatus and systems and methods for operating the same.

### BACKGROUND ART KNOWN TO THE APPLICANT

The turn-around time associated with the loading and unloading of heavy goods vehicles (HGVs) such as walled semis or flat-bed trailers or loaded truck chassis and cabs is one of the largest costs associated with the transport industry as it is inefficient to have a HGV operator idle for long periods and ways and means to cut down this turnaround time are always being sought by the industry. For example, a loading and unloading evolution in the Takkyubin (Japanese National Delivery Service provided by such companies as Kuroneko Yamato and Sagawa Kyubin) service can take approximately two hours (or more) per 9.2 meter (Giga type) HGV body.

Front landing gear systems for walled semi-trailers typified by US 2015/0175136 and CA2779959 are well known and enable the cab (or ‘prime mover’) to separate from the trailer and once separated, the cab can be used to pick up and transport another semi-trailer whilst the existing trailer is able to be kept in parallel horizontal alignment with the ground to facilitate its unloading and possibly its re-filling. Flat-bed trailers (essentially un-walled semi-trailers) offering direct access to the goods stored on the trailer bed in principle, also offer faster unloading than walled semi-trailers.

However, such a system is unlikely to benefit sole operators of such vehicles as they would need to have at least two trailers and would need to return to pick up the empty trailer once unloaded, so although such a system may be of some use to a fleet operator, it would typically not benefit the sole operator of a semi or flat-bed trailer and could not benefit the operator of a HGV where the cab was not demountable from the trailer.

Variants of such landing gear systems do however offer some additional benefits, as disclosed for example in JP2007-50890.

This enables the cab and trailer to be raised at the cab end of the semi, tilting the trailer enabling the unloading of goods carried on the trailer to be facilitated at a faster rate but there would still be a lag in turnaround time associated with such a system. It would also somewhat restrict the operator to essentially ‘tippable’ goods and not much else.

Accordingly, it is an object of the present invention to try and alleviate the aforementioned problems.

For the avoidance of doubt, in this specification the term ‘heavy goods vehicle’ or ‘HGV’ includes those of the type known generally as an ‘empty truck chassis and cab’.

Furthermore, a goods containing transport container, detachable HGV body, flat bed or curtain sided container in this specification is simply referred to as ‘goods’.

### STATEMENTS OF THE INVENTION

With the foregoing in view, the invention, although embodied in several different aspects, is so linked as to form part of a single general inventive concept.

Accordingly, the invention in one aspect resides broadly in a vehicle outrigger and landing gear apparatus adapted to be completely separable from a vehicle it is intended to be supported on including:
a goods supportable frame mountable to a heavy goods vehicle (HGV);
a plurality of moveable outrigger arms fitted to the frame each moveable between a stowed and a deployed position;
a landing gear including a ground contactable leg operatively connected to each outrigger arm and moveable between a stowed and a deployed position to support the frame above the ground in the deployed position; and
a plurality of locking pins each moveable between a locked and an unlocked position so as to lock each of the arms and legs in either their stowed or deployed position: their arrangement being such that when the apparatus in its fully deployed position, the entire apparatus is located at a distance from a vehicle able to carry/support the apparatus, when the arms and legs are in their stowed position.

When such a piece of apparatus is carried or fitted to a HGV, the deployment of the apparatus (which can be relatively rapid) when it is carrying goods, means that the HGV can simply drive away from the transport container or goods now supported on the deployed free-standing apparatus, to pick up another container or goods ladened apparatus. At the same time, when the apparatus is in its deployed position and supporting the weight of the goods, it is locked into place by the locking pins providing added safety. In fact, the locking pins are so designed (see later) as to ensure that the arms and legs are dead-locked into place when either are in their respective stowed or deployed positions.

Alternatively, the vehicle can go on to drive and stop under a similarly deployed apparatus supporting either an empty transport container or nothing at all, which can then be rapidly collapsed back into its stowed position and onto the HGV, enabling the vehicle to be directly loaded with goods.

The goods supportable frame mountable to a HGV could be mounted to a flat-bed (without enclosing structure) trailer of a HGV alternatively, it is mounted to the chassis of a HGV.

The apparatus may include means to engage and disengage the frame from a chassis of a HGV. This has the advantage of enabling the frame to be securely engaged to the vehicle during transportation.

The locking pins are substantially quadrilateral in cross-section throughout their length. Although angled pins would be harder to fabricate than round ones, such a flat or angled cross-section is more beneficial as the main weight bearer along both horizontal and vertical axes are on the pins. Flat as opposed to round or elliptical surface areas have a larger surface area and would distribute the weight better. In such form, a groove or notch added to the pins allows for a better locking mechanism.

The arms may be provided with biasing means adapted to provide a bias towards the deployed position of the arm.

Such an arrangement could assist in dead-locking the locking pin when each arm is in its locked or in its stowed position.

At least one locking pin and at least one of an arm and a leg are provided with mutually cooperating tongue and groove portions to provide dead-locking of the locking pin. In the stowed position, such an arrangement together with the bias, means that the locking pin cannot accidentally unlock (and move from the locked position to the unlocked position) and can only unlock with the application of either a pneumatic air source or manual pressure. When using manual pressure, initially to a leg a crow bar could be slid into an aperture in the leg and lilting the leg or the leg could be supplied with grab handles. This lifting unlocks the dead-lock allowing the locking pin to be moved. Once the leg is no longer ground engaging, the arm can be similarly slid towards the stowed position to unlock the dead-locking caused by the tongue and groove. In such form, the biasing means is a spring.

The arms and legs could in principle move from a stowed position to a deployed position through a scissor action, alternatively, the arms and legs could be adapted to telescopically extend when they move from their stowed to their deployed position.

A plurality of locking pins may be employed in an arm. With such an arrangement, as any form of load e.g. a filled (or empty) transport container supported on the frame of the deployed apparatus acts through the legs in a cantilever action in the vertical plane, the larger the number of locking pins in the arms the better as it helps to split the load, between them. By contrast the load in the legs acts vertically through the leg and can easily be borne by the single pin in the orthogonal plane. Typically therefore, more locking pins are used in the arms than the legs.

Although the arms and legs and even the locking pins of the apparatus could be manually or hydraulically operated, it is particularly preferred if the apparatus is adapted to be pneumatically operable as then, the apparatus could, in principle be so arranged as to be connectable to the pneumatic system of a HGV.

This is a requirement as the vehicle raises and lowers itself whereas the legs themselves do not possess any lifting capability on their own, with their pneumatic cylinders only used for deployment and retraction.

The legs receive the pneumatic pressure from the vehicle because the cylinders in the legs are unlikely to possess sufficient lifting capability to lift either an empty or fully laden transport container on their own because their design specification only requires the capacity to deploy the legs, in such form, the combined designed lifting capability of all of the pneumatically operable legs is likely to be about 150 kg, or less.

By comparison, a typical pneumatic suspension of a HGV is meant to be able to lift no to 24 tons based on the vehicle type, and consequently they possess huge pneumatic air bags to be able to do that as part of the vehicle's pneumatic suspension system. With such an air bag, initially raising the fully laden HGV using the vehicle's own pneumatic system and subsequently deploying the vehicle outrigger and landing gear apparatus using the same pneumatic system simply makes more sense than designing a separate system.

The invention includes within its scope a HGV incorporating the apparatus as specified hereinabove.

The invention further includes within its scope a HGV incorporating the apparatus as specified hereinabove, carrying goods or an empty transport container, detachable HGV body, fiat bed or curtain sided container.

In another aspect, the invention resides broadly in a system to enable a HGV to rapidly off-load the goods it is carrying including:
a vehicle outrigger and landing gear apparatus adapted to support a load the apparatus including:
   a goods supportable frame mountable to a HGV, this could be mountable to the chassis;
   a plurality of pneumatically moveable outrigger arms fitted to the frame each moveable between a stowed and a deployed position;
   a landing gear including a ground contactable leg operatively connected to each outrigger arm and pneumatically moveable between a stowed and a deployed position to support the frame above the ground in the deployed position; and
   a plurality of locking pins each moveable between a locked and an unlocked position so as to lock each the arms and legs in their stowed or deployed position; and
HGV including:
   means to connect the vehicle's pneumatic system to the pneumatically operable arms and legs of the vehicle outrigger and landing gear apparatus.

Providing both the apparatus and the HGV together, as part of a system, means that the HGV can operate the apparatus and this will enable a HGV to off-load the goods carried on the vehicle outrigger and landing, gear apparatus and subsequently drive off to pick up for example more goods carried on a vehicle outrigger and landing gear apparatus, or a non goods supporting vehicle outrigger and landing gear apparatus far more rapidly.

Several ways might be envisioned by which the HGV pneumatic system could be connected to the pneumatic systems of the apparatus, one such system includes a control box provided with actuation means to control the locking pins, and the pneumatically operable arms and legs.

To prevent accidental disengagement of a locking spring, a locking pin could be provided with biasing means adapted to bias the locking pin towards an engaged (or locking) position. In such form the biasing means is a spring.

However, such a biasing means will only be present once in an arm containing multiple locking pins. This is because it would be quite impossible for a single operator to manually override two locking pins in the same arm to move the arm inwards in the event of a pneumatic failure

The system could further include means to engage and disengage the frame from the chassis.

The arms may be provided with biasing means adapted to provide a bias towards the deployed position. In such form the bias could be a spring.

The arms and legs could be adapted to telescopically extend when they move from their stowed to their deployed position. Telescopic extension would enable the use of a pneumatic piston to be employed to assist with the telescoping.

The use Of two locking pins could be used for each arm.

The invention in yet another aspect resides broadly in a method of off-loading a NOV comprising:
providing a HGV containing goods on a leg containing goods supportable frame;
raising the frame to enable the legs to deploy and separating the leg containing, goods supportable frame from the vehicle, when the frame legs become ground contacting; and
allowing the vehicle to move off leaving the goods to be unloaded from the frame.

The leg containing goods supportable frame could be the apparatus as specified herein.

The apparatus could be maintained in place on the chassis by a series of downwardly depending tangs, alternatively, if the method further includes the step of unlocking the goods supportable frame from the chassis.

Providing a lockable system has the advantage that the apparatus could not accidentally separate from the chassis if the vehicle ended up on its side through for example a collision, thus minimising potential collateral damage.

Raising the frame may occur when the pneumatic suspension of the vehicle is operated and the legs are fully extended and locked into position prior to becoming ground contacting.

Separation occurs as the vehicle lowers.

Such a method would greatly decrease the turnaround time for vehicle operators as the rapid off-loading of the transported goods (enabling it to be unloaded at a different time) yet allowing the HGV operator to move off after off-loading is a fax faster arrangement than Waiting for the goods that have been transported, to be unloaded.

As it is envisioned that a raised unloading area (loading bay) will be present in the unloading area and the goods are off-loaded adjacent this area, the frame remains in its raised state by being supported on its deployed legs during unloading and it required subsequent reloading.

During recovery of the frame, a HGV positions it's chassis underneath the frame which is standing on its legs. The vehicle then pneumatically raises itself on its pneumatic suspension such that the chassis contacts the underside of the frame lifting it slightly such that the legs are no longer in contact with the ground.

The frame is then secured to the chassis and reconnected to the pneumatic system of the vehicle and the legs and outriggers (in the case of the present apparatus) are retracted and the vehicle then lowers back to its normal driving position height and the vehicle is now able to drive off.

### BRIEF DESCRIPTION OF THE DRAWINGS

In order that the invention may be more readily understood and put into practical effect, reference will now be made to the accompanying drawings wherein:

FIG. 1 is an isometric view from above of a vehicle outrigger and landing gear apparatus according to one embodiment of the invention and shows the apparatus in its stowed and telescopically deployed positions;

FIG. 2 is an isometric view from above of an arm and leg and locking pin of the vehicle outrigger and landing gear apparatus illustrated in FIG. 1 in both be deployed states but without the locking pins in their locked positions to demonstrate how everything connects together;

FIG. 3 illustrates side and plan elevations of a locking pin showing inter alia a pair of milled key slots in the locking pin body;

FIG. 4 illustrates front, sectional side and plan elevations of a locking pin in place in the apparatus;

FIG. 5 illustrates sectional front and side elevations of the arm and leg of the vehicle outrigger and landing gear apparatus illustrated in FIG. 2:

FIG. 6 illustrates sectional front and side elevations of the outer part of the leg of the vehicle outrigger and landing gear apparatus illustrated in FIG. 2;

FIG. 7 illustrates sectional front and side elevations of the inner telescopic arm of the vehicle outrigger and landing gear apparatus illustrated in FIG. 2 normally housed within the outer part of the arm illustrated in FIG. 8 below;

FIG. 8 illustrates sectional front and side elevations of the outer part of the arm of the vehicle outrigger and landing gear apparatus illustrated in FIG. 2 which houses the inner telescopic arm illustrated in FIG. 7;

FIG. 9 illustrates sectional front and side elevations of the inner telescopic leg of the vehicle outrigger and landing gear apparatus illustrated in FIG. 2 normally housed within the outer part of the leg illustrated in FIG. 6;

FIGS. 10-12 illustrate how the apparatus when operatively connected to a heavy goods vehicle (HGV) to form a system, deploys from its stowed to its deployed position;

FIG. 13 illustrates a pictorial representation of a control box, which serves to connect the pneumatic system of an HGV to the pneumatic components of the vehicle outrigger and landing gear apparatus of FIG. 1; and

FIG. 14 illustrates how the locking pin mechanism of the locking pin of FIGS. 2-4 operates when moving from its unlocked to its locked position.

### DESCRIPTION OF THE PREFERRED EMBODIMENT

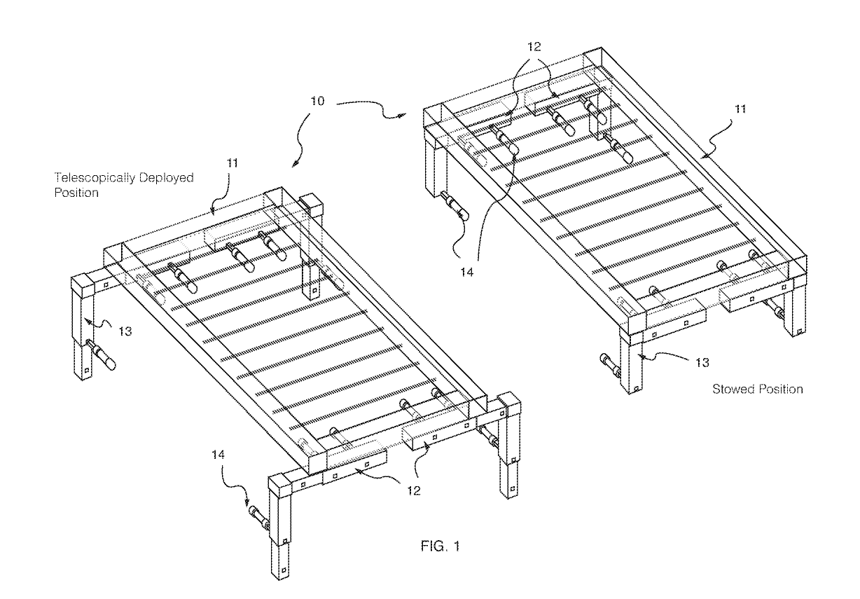

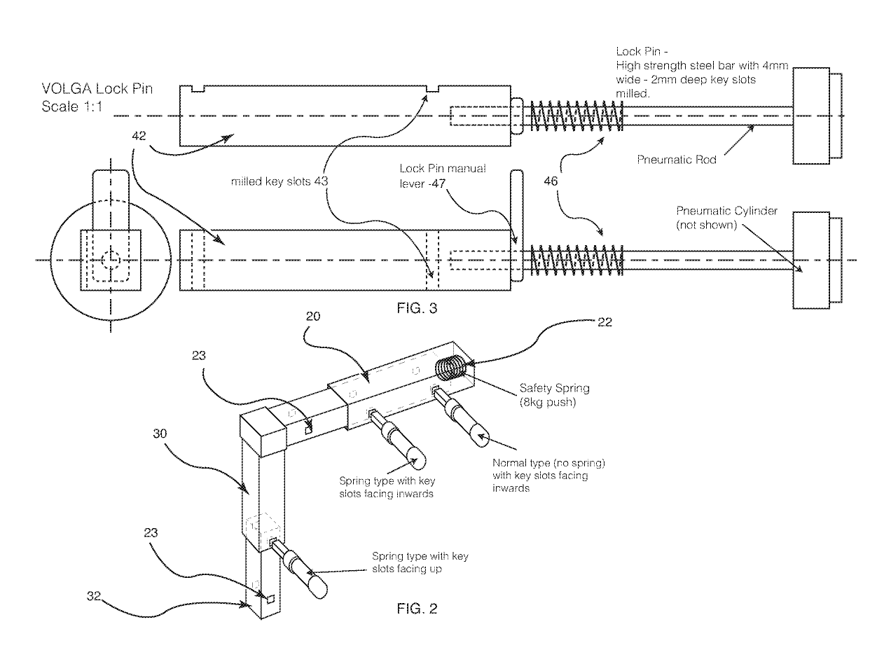

FIG. 1 shows a vehicle outrigger and landing gear apparatus of the present invention generally referenced 10, which is adapted to be completely separable from a heavy goods vehicle (HGV) to which it is intended to be carried on, and operatively connected to.

In addition, the apparatus 10 will allow goods, carried by the HGV and mounted on top of the goods supportable rectangular frame 11 to freely stand on the apparatus 10 when the apparatus 10 is in its fully deployed position.

The frame 11 is mounted to four horizontal, elongate, telescopically extendible outrigger arms 12, the arms 12 being adapted to be moveable from a stowed to a deployed position. A landing gear including a vertical elongate telescopically extendible ground contactable leg 13 is operatively connected to the deployable (or distal) end of each of the outrigger arms 12, which is also moveable between a stowed and a deployed position to support the frame 10 above the ground in the deployed position. The apparatus 10 also contains in this embodiment, a pair of locking pins 14 per arm 12 and a single locking pin 14 per leg 13. Each of the locking pins 14 is adapted to be moveable (see later) between a locked and an unlocked position so as to lock each of the arms 12 and legs 13 in either their stowed or deployed position.

The arrangement of the aforementioned component parts of the apparatus 10 are such that when the apparatus 10 in its fully deployed position, on account of both the horizontal and vertical telescopic extension, the entire apparatus 10 is located at a distance from a vehicle able to carry the apparatus 10.

Each arm 12 comprises a square outer housing sleeve 20 which, at its proximal end houses one end of an outrigger pneumatic deployment piston and return cylinder 21, together with a safety spring 22. Four square holes 23 are present, two in each opposing side of the housing 20 to accommodate a pair of slidable locking pin 14. In addition each arm 12 comprises an inner telescoping outrigger sleeve 24 concentric with the outer sleeve 20, including roller bearings 25 which will reduce friction on inner sleeve 24 as it moves from its stowed to its deployed position.

Similar holes 23 are located on the inner sleeve 24 which can overlie with the holes of the outer sleeve 20 when the inner sleeve 24 moves relative to the outer one 20. Inner sleeve 24, towards its distal end, is provided with an internally fitted downwardly depending mounting plate 26 in its intended attitude of operation which acts as a securing point for the other end of the outrigger pneumatic deployment piston and return cylinder 21.

The distal end of the inner sleeve 24 is covered with a plate 27 which acts as a mounting plate and bolt holes for the proximal end of the outer housing sleeve of a leg 13.

In a similar manner to the arm 12, each leg 13 comprises a square outer housing sleeve 30 is a hollow square tube which, at its proximal end houses one end of another outrigger pneumatic deployment piston and return cylinder 31. Two square holes 23 are present in each opposing side of the outer housing 30 to accommodate a slidable locking pin 14. In addition each leg 13 comprises an inner telescoping landing sleeve leg 32.

The inner sleeve 32 possesses an internally fitted horizontally projecting mounting plate 33 in its intended attitude of operation, which acts as a securing point for the other end of the outrigger pneumatic deployment piston and return cylinder 31. Similar holes 23 are located on the inner sleeve 32 which can overlie with the holes of the outer sleeve 30 when the inner sleeve 32 moves relative to the outer one 30.

The distal end of the inner leg 32, is provided with a rubber foot 34 and grab handles 35 in the form of a square hollow tube which slides inside the outer housing 30 of the leg 13. The grab handles 35 are provided in case an operator wants to actuate a leg 13 in a manual override mode without the aid of pneumatics.

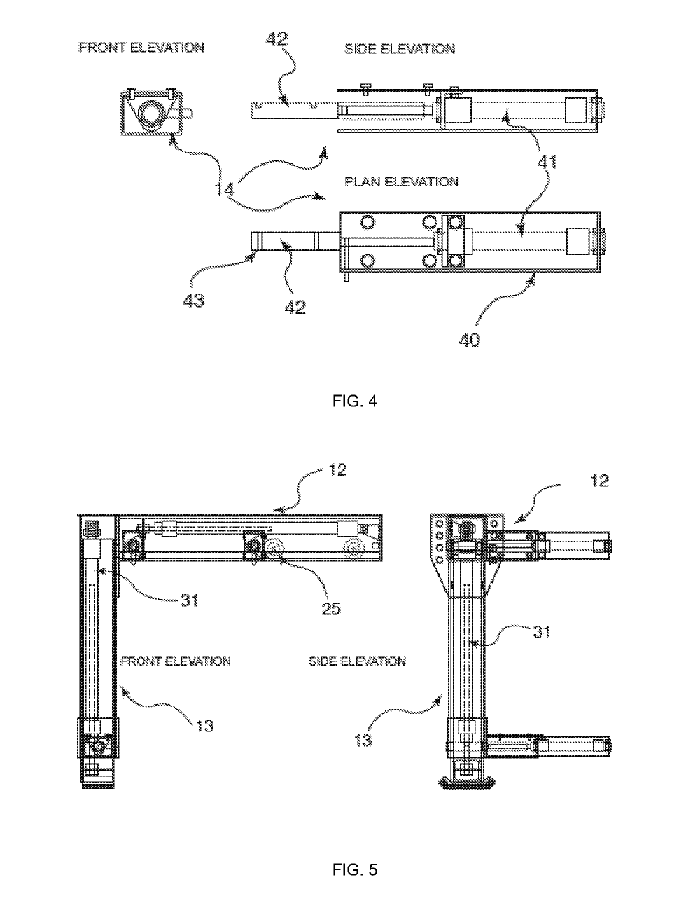

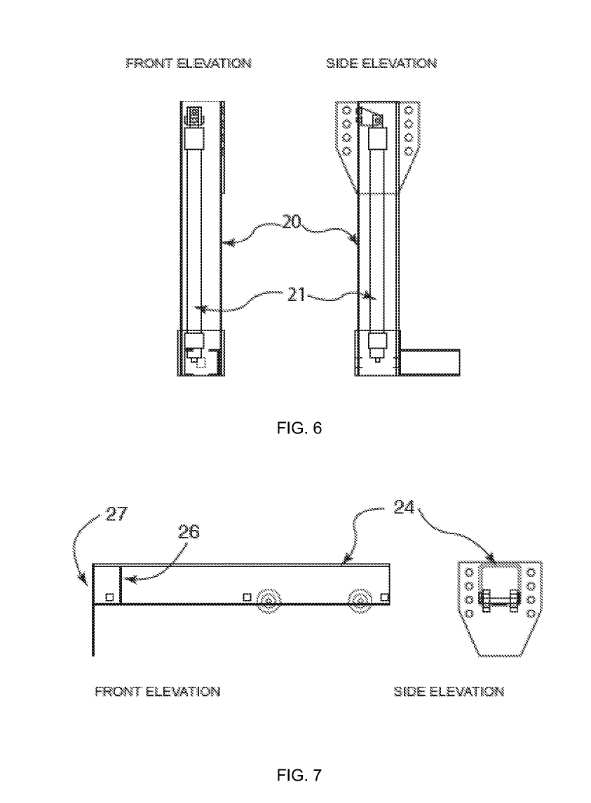

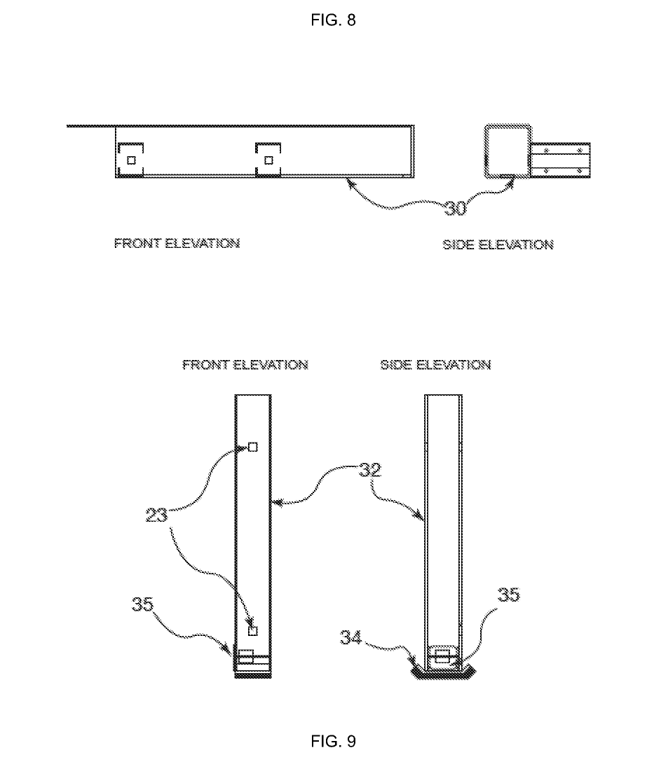

From FIG. 4, each locking pin 14 is maintained within a housing 40 and is pneumatically operable and comprises a pneumatic cylinder 41 attached to a square cross-sectioned lock pin body 42 of high strength non-corrosive steel which is so dimensioned as to provide a complementary sliding-fit arrangement with apertures 23. The body 42 possesses a pair of 5 mm wide by 5 mm deep milled elongate square slots 43 designed to accommodate mutually cooperating end portions 44 of the inner telescoping outrigger sleeve 24 to form a tongue and groove arrangement when locked together.

The end portions 44 are urged into milled slots 43 by the safety spring 45 and as a result of the spring 45, positive pressure has to be applied to the inner telescoping outrigger sleeve 24 to ensure its full retraction.

This arrangement provides a dead-lock when the inner tele-scoping outrigger sleeve 24 comes to rest when the pneumatic air source is turned off and an identical tongue and groove arrangement exists for the leg 13. In the latter case however, no safety spring 45 is required, as the tongue will be urged into the groove through the action of gravity.

In case of a pneumatic failure of the arms 12 or legs 13, they can be manually overridden by lifting the grab handles 35 to disengage the dead-locking provided by the tongue and groove and similarly the arm 12 can be pushed inwardly towards the frame 11 to push against the bias of spring 22 to similarly disengage the tongue and groove deadlocking.

An additional safety spring 46 is provided on the pneumatic sleeve 41 of the locking pin 14 to bias the locking pin 14 towards the locked position, thus ensuring that in the unlikely event of the locking pin becoming disengaged from the dead-lock and slipping out, the locking pin 14 will be unable to fully slide out of the apertures 23 as the spring 46 will always bias the locking pin 14 towards and thus retain it within the apertures 23. This feature may be considered to be double redundancy but is an additional safety feature of the apparatus and system.

The locking pins 14 themselves are the main load bearers both along the vertical plane (for the landing gear legs 13) and horizontal (outrigger arms 12) plane and in the illustrated embodiment, three locking pin assemblies are required for each combined arm 12 and leg 13.

Similarly the locking pin is provided with a manual override in the form of a spigot 47. Freely sliding along the looking pin shaft is the safety spring 46 which requires positive pressure provided pneumatically or manually. By pulling the spigot, the locking pin 14 can be manually disengaged from the arm 12 or leg 13. Manually sliding the locking pin towards the open position would compress the safety spring 46 but would allow for manual disengagement of the locking pin 14.

In this embodiment containing two locking pins 14 in the arm 12, the proximal (inner) locking pin does not have the safety spring 46, only the outer one does. This is because it would be quite impossible for a single operator to manually override two locking pins 14 in the same arm 12 to move the inner telescoping outrigger sleeve 24 inwards in the event of a pneumatic failure.

Accordingly, only one locking pin per arm is provided with a safety spring 46. The leg in this particular embodiment will always contain a locking pin 14 with a safety spring 46 as there is only one locking pin 14 per leg 13.

A control box 50 is also provided (intended to be located away from moving parts for safety reasons) on the chassis which serves as a means of:
a) conveniently linking the pneumatic system of the HGV to the pneumatic systems 21, 41 of the apparatus 10;
b) arranging the hoses 57 required in an ordered manner; and
c) actuation for the combined apparatus and HGV system which will enable the HGV to rapidly off-load the goods it is carrying;
   comprises a pair of mechanical valves 51, 52:
i) the first valve 51, for the simultaneous control, activation and return of all of the locking pin 14 pneumatic cylinders 41; and
ii) the second valve 52, for the simultaneous control, activation and return of all of the outrigger arms 12 and legs 13.

Essentially a disconnectable 10 mm hose 54 connected to the HGVs pneumatic system enters control box 50 and a bundle of hoses 55 exit the control box 50. The hoses 57 employed throughout are colour coded to aid identification if there is a problem. In addition, a master switch 53 is provided to turn on/shut-off the air supply prior to the HGV moving between locations. The master switch should be in the on position only when operating the apparatus. Air divider units 56 are also supplied to split the pneumatic air from the valves into four to six outlets depending on the number of outrigger legs in the system.

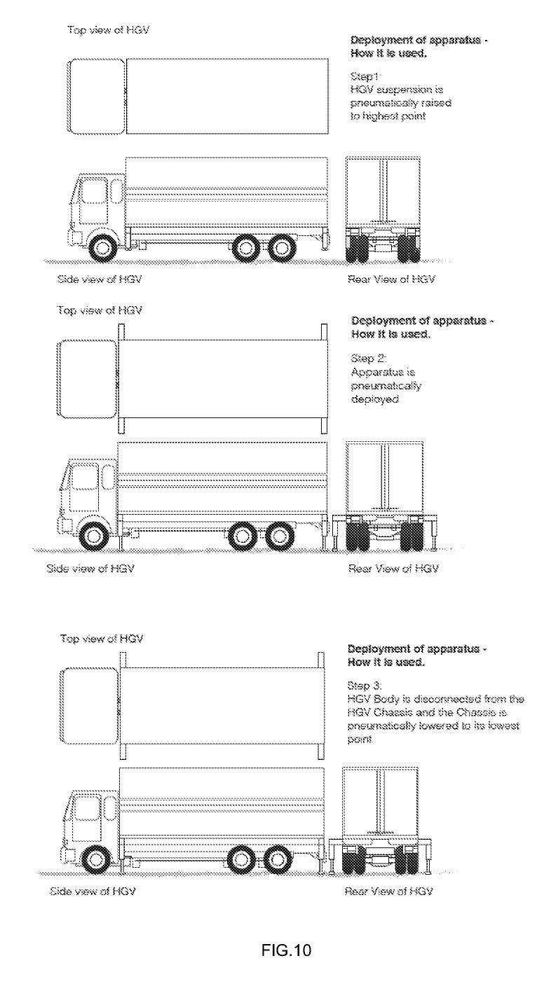

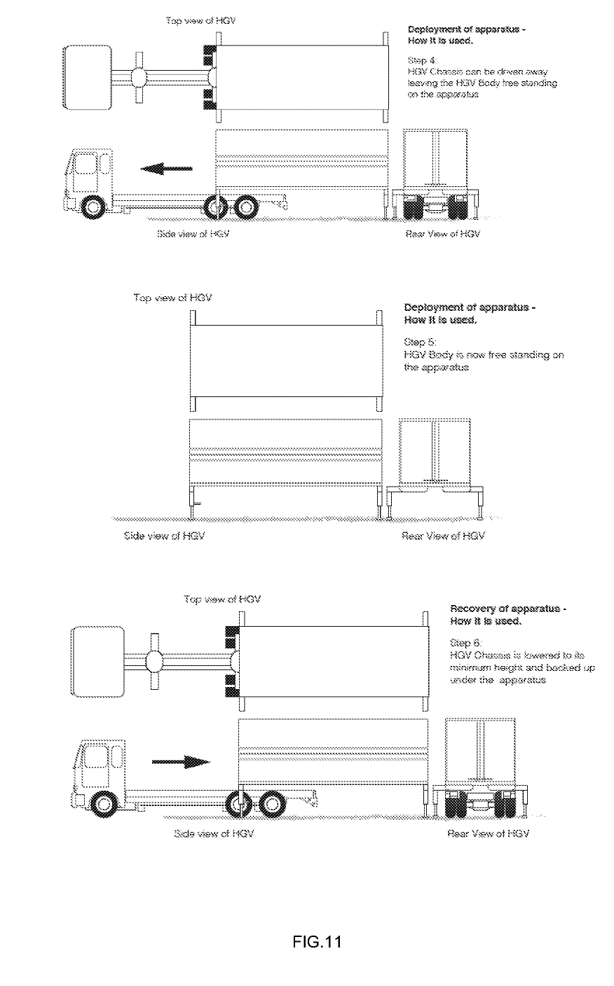

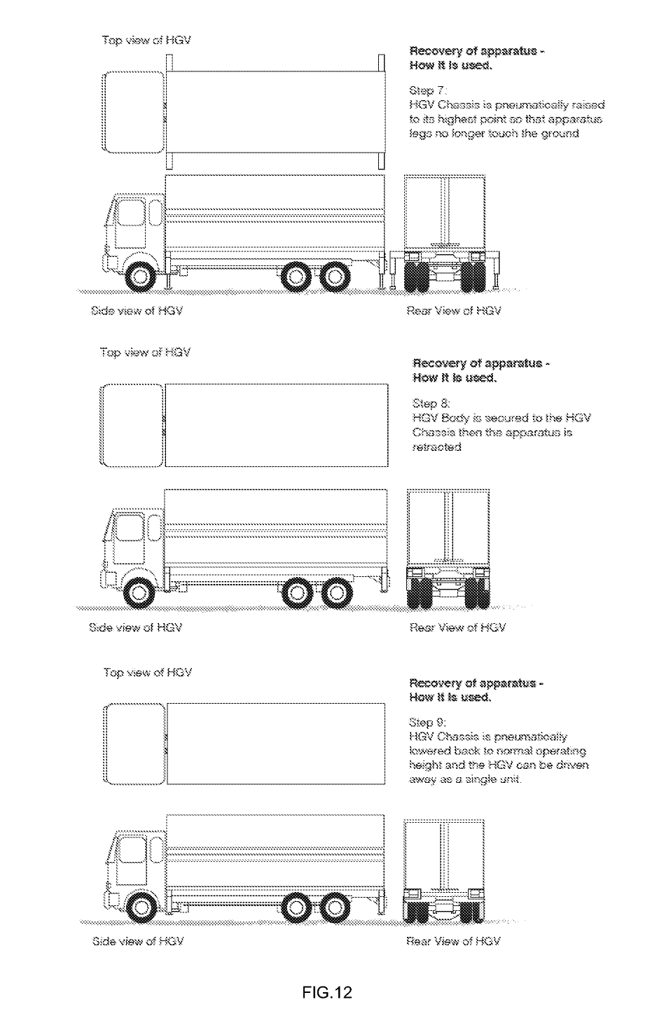

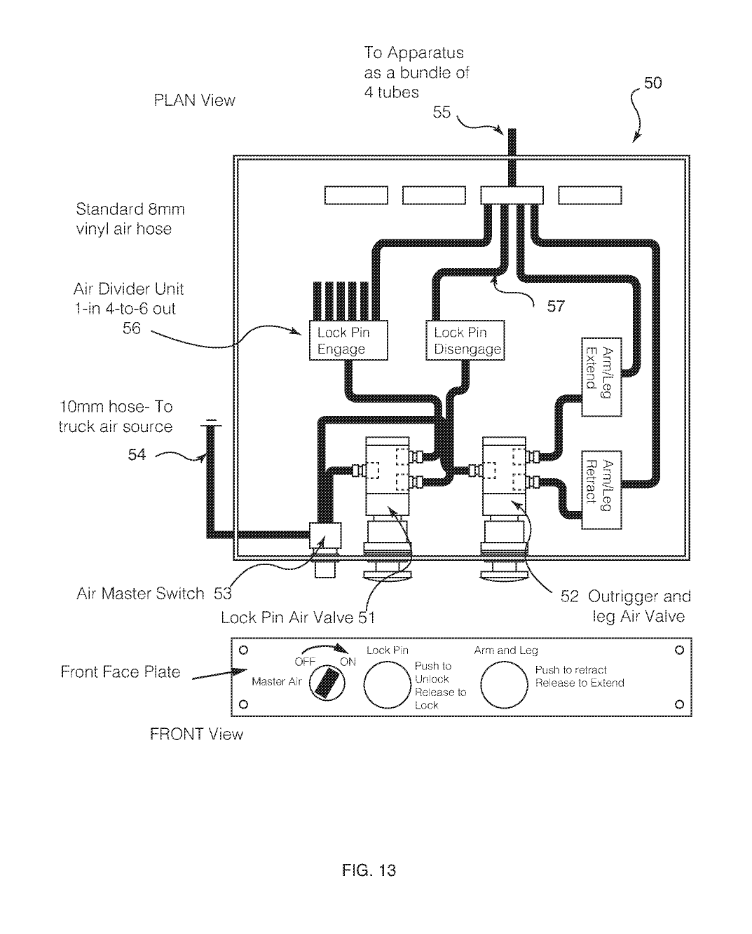

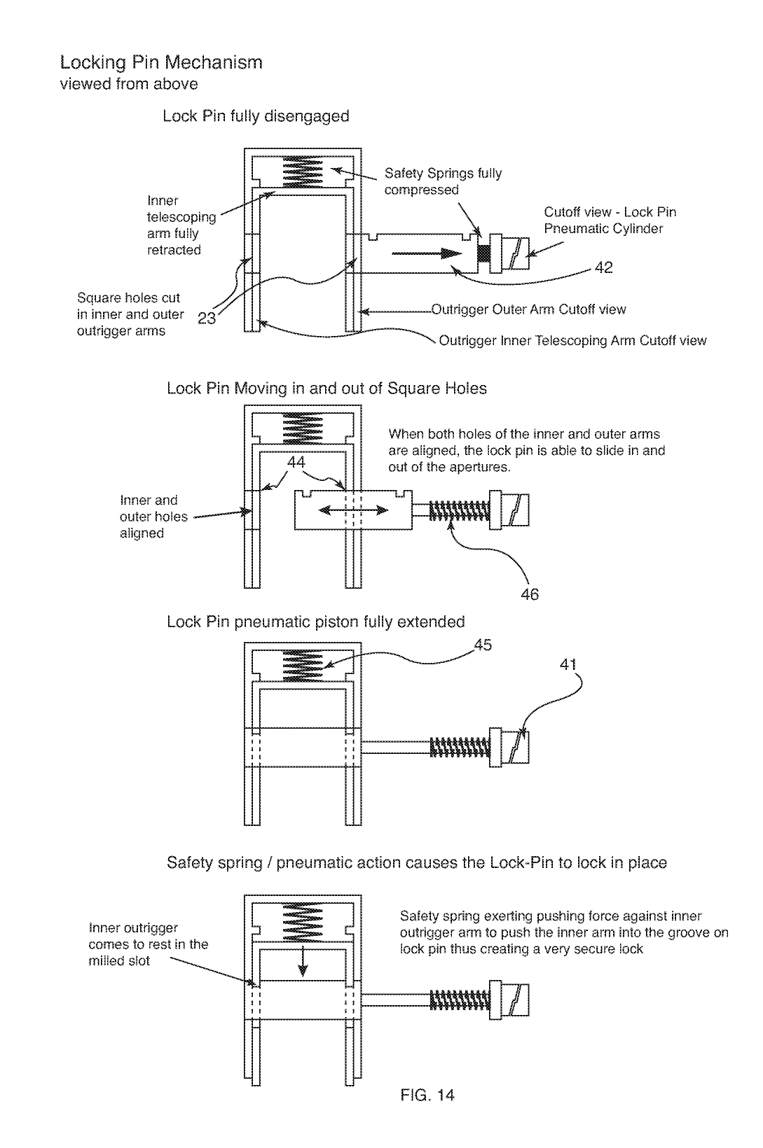

FIGS. 10-12 illustrate the apparatus 10 described above mounted to and operatively connected to a HGV to form a system which acts together. The system illustrated comprises an empty truck chassis and cab fitted with the apparatus and a carrying goods and when fully deployed will enable the chassis unit to drive away while the goods remain standing on the legs 13 of the apparatus 10. The system is primarily employed where it is desirable to allow goods to be unloaded or an empty transport container, detachable HGV body, fiat bed or curtain sided container to be filled at a raised loading bay platform while it is standing directly on the deployed apparatus 10. The HGV, now detached, can be driven to pick up more goods. (or an empty transport container, detachable HGV body, flat bed or curtain sided container) which is ready for delivery. This type of system will allow an increase in efficiency of the truck use and lower overall costs.

A method of operating the system is also shown in FIGS. 10-12 and is summarised below.

### Deployment Operation

The HGV comes to a complete stop on flat ground typically backed up to a loading bay. While the goods is still resting firmly on the frame 11 detachably mounted to the chassis, the securing devices or lock that secures the frame to the chassis are disengaged. The HGV is then raised on its pneumatic suspension system to its highest possible level (or a height determined by the operator depending on conditions) and locked in place, with the engine still running.

This provides compressed air for operation of the pneumatic system. The operator first ensures that the master switch 53 is in the “ON” position and supplies compressed air to the pneumatic system to the apparatus. The operator then pushes and holds down valve actuator 52 to fully retract the inner arm 24 so that the dead-lock is released. Whilst maintaining the actuation of valve actuator 52, valve actuator 51 is pushed and held down, which causes the locking pins 14 to disengage and move from their locked to their unlocked position.

The operator then releases valve actuator 52 which causes the inner telescoping outrigger arm 24 and the inner telescoping landing sleeve leg 32 to extend respectively to their fully extended position. The operator then releases valve actuator 51 causing the locking pins 14 to move from their unlocked to their locked position, preventing the inner arms 24 and inner legs 32 from retracting.

The operator then rotates the master switch 53 to its “OFF” position and that disconnects the 10 mm hose 54 from the control box 50. The operator finally pneumatically lowers the suspension of the chassis of the HGV to its lowest point and is then able to safely drive the chassis away now that the goods are free standing on the apparatus 10.

### Stowing Operation

The operator pneumatically lowers the chassis to its lowest position, and positions the chassis directly below the apparatus 10 supporting either goods, or an empty transport container, detachable HGV body, flat bed or curtain sided container and aligned correctly. Subsequently the operator pneumatically raises the chassis to its highest position by which point, the feet are no longer in contact with the ground, and secures the chassis to the frame of the apparatus 10 by means of the locking system and reconnects the 10 mm hose 54 to the control box 50, followed by turning the master switch 53 into the “ON” position.

Once the legs 13 are no longer in contact with the ground, and air is supplied to the system, the locking pins 14 are able to disengage normally. The operator then presses and holds down valve actuator 51, which causes the locking pins 14 to disengage and move from their locked to their unlocked positions. Whilst maintaining the actuation of valve actuator 51, valve actuator 52 is pushed and held down to fully retract the inner arm 24 and raise the inner telescoping landing sleeve lea 32. Continuing to maintain pressure on the valve actuator 52, causes the inner telescoping outrigger arm 24 and the inner telescoping landing sleeve leg 32 to retract respectively to their stowed position.

The operator then releases valve actuator 51 causing the locking pins 14 to move from their unlocked to their locked position, preventing the inner arms 24 and inner legs 32 from deploying.

The operator then releases valve actuator 52 which causes the inner arm 24, and the inner telescoping landing sleeve leg 32 to form a dead-lock with the locking pin 14. The operator then rotates the master switch 53 to its “OFF” position. The operator is then in a position to secure or lock the fame to the chassis and lower the chassis to the normal driving position, before driving away.

The system can be operated by a single person and (excluding chassis raising and lowering) has a cycle time of less than 30 seconds which greatly reduces the turn-around time for both loading and unloading an HGV and can be used with the chassis of a single (rigid) HGV or the chassis of an articulated HGV.

The system is so adapted to be able to carry a static load of 10 tons per leg, which when combined typically exceeds the maximum cargo weight of a HGV by at least three times. A manual override system is in place and deployment possible in case the pneumatic system fails.

In alternative non-illustrated embodiments the number of arms and legs of the apparatus can increase typically from four to six. If the number of locking pins 14 increases in the legs, only one of the locking pins 4 in the leg will contain the safety spring 46 for the same reasons as explained with the arm herein above.

1. A vehicle outrigger and landing gear apparatus adapted to be completely separable from a vehicle it is intended to be supported on including:
a goods supportable frame mountable to a heavy goods vehicle (HGV);
a plurality of moveable outrigger arms fitted to the frame each moveable between a stowed and a deployed position:
a landing gear including a ground contactable leg operatively connected to each outrigger arm and moveable between a stowed and a deployed position to support the frame above the ground in the deployed position; and
a plurality of locking pins each moveable between a locked and an unlocked position so as to lock each of the arms and legs in either their stewed or deployed position;
their arrangement being such that when the apparatus in its fully deployed position the entire apparatus is located at a distance from a vehicle able to carry the apparatus, when the arms and legs are in their stowed position.

2. The apparatus as claimed in claim 1, wherein the goods supportable frame is mountable to a chassis of a HGV.

3. The apparatus according to claim 1 or claim 2, further including means to engage and disengage the frame from a chassis of a HGV.

4. The apparatus according to claim 1, wherein the locking pins are substantially quadrilateral in cross-section throughout their length

5. The apparatus according to claim 4, wherein at least one locking pin and at least one of an arm and a leg are provided with mutually cooperating tongue and groove portions to provide a means of dead-locking the locking pin when it is in either its locked or unlocked position.

6. The apparatus according to claim 1, wherein the arms are provided with biasing means Adapted to provide a bias towards the deployed position.

7. The apparatus according to claim 1, wherein the arms and legs are adapted to telescopically extend when they move from their stowed to their deployed position.

8. The apparatus according to claim 1, wherein the number of locking pins per arm is twice the number per leg.

9. The apparatus according to claim 1, wherein the apparatus is adapted to be pneumatically operable.

10. A HGV incorporating the apparatus as claimed in claim 1.

11. A HGV as claimed in claim 10, carrying goods or an empty transport container, detachable HGV body, flat bed or curtain sided container.

12. A system to enable a HGV to rapidly off-load the goods it is carrying including:
a vehicle outrigger and landing gear apparatus adapted to support a load the apparatus including:
a goods supportable frame mountable to a HGV, which could be its chassis;
a plurality of pneumatically moveable outrigger arms fitted to the frame each moveable between a stowed and a deployed position;
a landing gear including a ground contactable leg operatively connected to each outrigger arm and pneumatically moveable between a stowed and a deployed position to support the frame above the ground in the deployed position; and
a plurality of locking pins each moveable between a locked and an unlocked position so as to lock each of the arms and legs in their stowed or deployed position; and
a HGV including:
means to connect the vehicle's pneumatic system to the pneumatically operable arms and legs of the vehicle outrigger and landing gear apparatus. The system according to claim 12, further including a control box provided with actuation means to control the locking pins, and the pneumatically operable arms and legs.

14. The system according to claim 12 or claim 13, further including means to engage and disengage the frame from the chassis.

15. The system according to claim 12, wherein the arms are provided with biasing means adapted to provide a bias towards the deployed position.

16. The system according to claim 12, wherein the arms and legs are adapted to telescopically extend when they move from their stowed to their deployed position.

17. The system according to claim 12, wherein a locking pin is provided with biasing means adapted to bias the locking pin towards an engaged (or locking) position.

18. The system according to claim 12, wherein a plurality of locking pins are employed in an arm.

19. A method of off-loading a HGV comprising:
providing a HGV containing goods on a leg contain g goods supportable frame;
raising the frame to enable the legs to deploy and separating the leg containing, goods supportable frame from the HGV, when the frame legs become ground contacting; and
allowing the HGV to move off, leaving the goods to be unloaded from the frame.

20. The method according to claim 19, wherein the leg containing goods supportable frame is the apparatus as claimed in claim 1.

21. The method according to claim 19 or claim 20, wherein the method further includes the step of unlocking the goods supportable frame from the chassis.

22. The method according to claim 19, wherein raising the frame occurs when the pneumatic suspension of the HGV is operated and the legs are fully extended and locked into position prior to becoming ground contacting.

23. The method according to claim 19, wherein, separation or off-loading occurs as the vehicle lowers.

24. The method according to claim 19, wherein the frame remains in its raised state during unloading.
